(19) United States
(12) Patent Application Publication
(10) Pub. No.: US 2013/0323701 A1
(43) Pub. Date: Dec. 5, 2013

(54) DEMONSTRATOR OF MULTIPLE STRESSES

(71) Applicants: Olivier Moulinjeune, Lyon (FR); Gilles Robert, Vernaison (FR)

(72) Inventors: Olivier Moulinjeune, Lyon (FR); Gilles Robert, Vernaison (FR)

(73) Assignee: RHODIA OPERATIONS, Aubervilliers (FR)

(21) Appl. No.: 13/877,872

(22) PCT Filed: Sep. 28, 2011
(86) PCT No.: PCT/EP11/66900

§ 371 Date: Jun. 21, 2013

(30) Foreign Application Priority Data
Oct. 4, 2010 (FR) 1058012

(51) Int. Cl. G09B 23/10; B29C 45/76; G06F 17/50

(52) U.S. Cl. CPC G09B 23/10; G06F 17/5009; B29C 45/76
USPC 434/302; 703/2; 264/40.1

(57) ABSTRACT

An article is described that can be used as a demonstrator of multiple stresses making it possible notably to compare the results of simulation tests for various types of mechanical stresses. The demonstrator can be an article made in a single piece out of plastic material having a ribbed central beam and two lateral plates. Bending, tensile, compression and torsion tests can notably be carried out on such a demonstrator.

The present invention relates to an article that can be used as a demonstrator of multiple stresses making it possible notably to compare the results of simulation tests for various types of mechanical stresses. This demonstrator is an article made in a single piece out of plastic material comprising a ribbed central beam and two lateral plates. Bending, tensile, compression and torsion tests can notably be carried out on such a demonstrator.

### PRIOR ART

Plastic materials such as thermoplastic, thermosetting or elastomeric materials are widely used for the manufacture of various articles such as molded and/or injected parts in particular, in many technical fields. These articles in their various uses sustain damage due to external stresses and particularly mechanical stresses that will diminish the mechanical properties of said articles. These problems may become critical for a certain number of applications, such as notably parts in the motor vehicle field which are notably subjected to considerable heat.

There are many finite element structural analysis software programs, such as: Abaqus® from Dassault, Ansys® from Ansys-INC, Radioss® from Altair, LS-Dyna® from LSTC and PamCrash® from ESI. These software programs make it possible to solve complex linear and nonlinear engineering problems by using finite element analysis. Specifically, these solving software programs compute the stress states on the plastic parts based on a grid of these parts. A grid is a spatial discretization of a continuous environment and a geometric modeling by finite and well-defined proportioned elements. These software programs are therefore used to optimize the design process and to solve the problems of product validation while minimizing the costs.

On nonhomogenous plastic formulations comprising additives and reinforcing or additive fillers, these software programs can give inaccurate results because they do not take account of the states of orientation of the fibers linked to the implementation by injection molding. Furthermore they do not have behavior models adapted to the plastic materials and their formulations that may comprise various fillers and additives, making it possible to describe the physical behavior associated with the use of this type of material.

Software programs now exist, such as the Digimat® program of e-Xstream, which operate for entering into collaboration with the structural programs so as to act together as a solver in order to improve the finite element stress simulations. Specifically, these software programs incorporate two information sets originating in the first place from the plastic formulations and their mechanical behaviors such as the elastic, elastoplastic, elasto-visco-plastic, thermo-elastic, fatigue behaviors; and secondly originating from injection simulation software programs such as Moldflow®, Moldex®, Sigma Soft® and REDM3D® which are used to carry out a simulation of injection of plastic parts and to determine the orientation of the glass fibers in the part as a function of the parameters of the injection molding. These software programs will provide the orientation tensors of the fibers of the plastic part. Such a collaboration between the software programs and the data on the formulations will therefore allow an improved simulation of the states of stress on the finite elements.

However, hitherto it has not been possible to perfectly correlate the results of these simulations with the concrete observations originating from the experimental tests because there was no complete article to do this. Specifically, for example the bending tests are conventionally carried out on ribbed beams while the compression, tension or tensile tests are carried out on normal or dumbbell test specimens.

These experimental results could therefore not be compared with the simulations on finished and injected articles. It was also not possible on this type of simple test specimen to make comparisons by using various injection points in order to assess the behavior of the fibers in the plastic matrix and therefore the mechanical behaviors associated with these injection points.

### DESCRIPTION OF THE INVENTION

The Applicant has just developed a particular injection-molded article called a demonstrator of multiple stresses. This article can be specifically dedicated in order to carry out different mechanical stresses, such as bending, tensile, compression and torsion tests. Therefore, from now onwards a single article can be used for all these tests. Moreover this article has sufficient complexity to make it possible to carry out a certain number of studies on the behavior and the orientation of the fibers in the plastic matrix as a function of the location of the injection points. This tool therefore becomes a preferred partner for comparing the experimental results with the various simulation tools mentioned above.

The present invention relates to an article, notably a demonstrator of multiple stresses, made in a single piece by injection molding of a plastic formulation and comprising:
an oblong, ribbed central beam 1, and
two ribbed plates 2 which are placed symmetrically and perpendicularly at the ends of said beam; each plate comprises at least two through-holes 3.

Such an article therefore has a symmetrical structure of the two plates relative to the central beam, notably in order to prevent deformations of the buckling type during the mechanical compression stresses.

The section of the ribbed beam may for example be T-shaped, U-shaped, I-shaped or dumbbell-shaped.

The plates may have various shapes, notably rectangular or circular.

Preferably the bearing face of a plate on the beam has a tapered and curvilinear shape in its connection to the beam; notably having a zone of connection with large radii of curvature, for example greater than 30 mm.

Preferably, the section of the beam has a dumbbell shape and the plates have a circular shape. In this case, the bearing face of a plate on the beam has a tapered and curvilinear shape in its connection to the beam; in order to link the rectangular section of the beam and the circular section of the plate to prevent the concentrations of stresses. Such a shape moreover makes it possible to localize the stresses on the central beam.

The article notably has plates reinforced by a network of ribs situated on the face opposite to the bearing face on the beam so that the ends are more rigid than the effective portion.

The article has a minimum number of holes for the attachment of two in order to limit the stresses and prevent the load dissymmetries; notably between four and ten holes, more preferably eight holes.

It should be noted that it is perfectly possible to add one or more inserts in the article, notably an insert made of metal or of composite material.

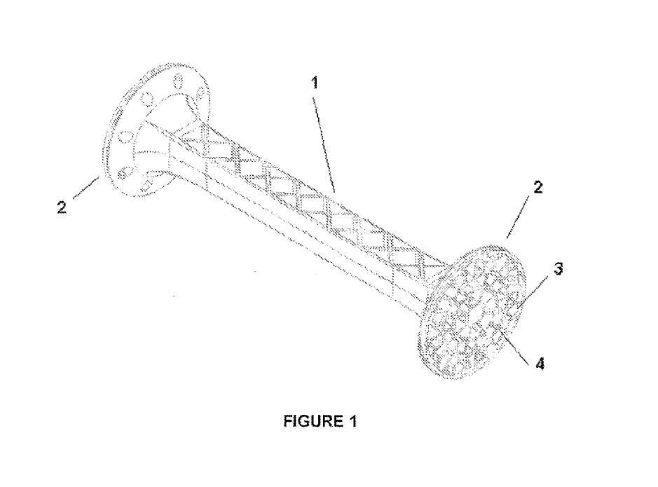

The invention will be better understood and other objects, features, details and advantages of the latter will become more clearly evident during the following explanatory description made with reference to the appended drawing given only as an example illustrating an embodiment of the invention and in which FIG. 1 is a schematic view in perspective of an article according to the invention comprising a ribbed beam 1 and two plates 2 themselves comprising ribs 4; said plates each comprising 8 through-holes 3.

The length of the beam is preferably greater than the diameter of the plates. Notably a ratio of beam length to diameter of the plates of between 2 and 10 is preferred.

Preferably the circular plates have the same diameter and in a yet more preferable manner the two circular plates have exactly the same shape.

The injection points for producing the article may be placed at different locations in the mold, such as notably at the plates or at the beam. The position of the injection point or points or points therefore makes it possible to have the glass fiber orientations and hence the microstructure of the article vary.

The plastic material may notably be a thermoplastic, thermosetting or elastomeric material. It is possible to cite as a thermoplastic material polyolefins, polyamides and polyesters.

The plastic formulation may comprise reinforcing or additive fillers which are fillers that are conventionally used. It is possible to cite notably reinforcing fibrous fillers, such as glass fibers, carbon fibers or organic fibers, the nonfibrous fillers, such as particulate, lamellar fillers and/or exfoliable or nonexfoliable nanofillers such as alumina, carbon black, glaze, zirconium phosphate, kaolin, calcium carbonate, copper, diatoms, graphite, mica, silica, titanium dioxide, zeolites, talc, wollastonite, polymeric fillers such as for example dimethacrylate particles, beads of glass or glass powder.

The plastic formulation may also comprise additives that are usually used. Therefore, it is possible to cite lubricants, fire retarding agents, plastifiers, nucleating agents, catalysts, antioxidants, impact reinforcing agents, antistatics, coloring agents, matifying agents, molding additives or other conventional additives.

These fillers or additives may be added to the plastic by usual means suitable for each filler or additive, such as for example during the polymerization of the plastic polymers or as a mixture in a melt, notably in extrusion.

The present invention also relates to the use of an article made according to the present invention as a demonstrator of multiple stresses; that is to say to carry out various mechanical stress tests. These tests may be conducted by having the external conditions such as the light, the temperature, the humidity or the presence of a fluid vary. These tests are conventionally bending, tensile, compression and torsion tests that are well known in the technical field.

The present invention also relates to a method for optimizing the structural analysis of a plastic article comprising at least the following steps:
a) carrying out experimental tests of mechanical stresses on the article, that is to say the demonstrator, of the present invention;
b) carrying out simulations of transformation by injection molding and calculations of mechanical stresses on a virtual model of the demonstrator of step a);
c) correlating the results of steps a) and b) so as to improve the finite element computing models and the laws of behavior of the materials.

The calculations of step b) may be carried out with the structure analysis software programs described in the introductory part.

The comparison of the results of step c) is carried out by any techniques that are considered necessary by those skilled in the art including in a non exhaustive manner: the comparison of the force-displacement, force-time or displacement-time curves, the observation of the deformation field by image correlation measurement, etc. In step c), the teaching that is drawn in a non exhaustive manner is the differences between calculations and tests, the identification of optimized parameters for the material laws, an improvement in the choice of materials, an improvement in the molding protocols.

As an example and for the optimization of the models and the laws of behavior of the compression strength of polyamide formulations, a demonstrator according to the invention is molded and a compression test is carried out in determined conditions according to step a). The result of this is a measurement of the force applied as a function of the rate of compression. A simulation of transformation by injection molding and calculations of compression stresses are then carried out on a virtual model of the demonstrator according to step b) using exactly the same molding and compression test conditions as in step a). The results of step a) and b) are then compared. If differences are observed between these results, the data of the finite element calculation models, of the injection simulation software programs and/or of the laws of behavior of the materials in compression are then modified so as to optimize them after they have been compared with a real case according to step a). This can be reproduced with various formulations comprising various ratios of additives, or even additives of different kinds. A data set is then obtained for various formulations and various mechanical properties in particular.

The present invention also relates to the use of the optimization of structural analysis of a plastic article as defined above in order to produce a plastic article by injection molding, on the industrial scale in particular.

The invention also relates to a method for manufacturing a plastic article by injection molding in which said article has been developed by using an article, that is to say the demonstrator of multiple stresses, as defined above, notably for the optimization of structural analysis of a plastic article. The invention also relates to a method for manufacturing a plastic article by injection molding in which said article has been developed by using an optimized structural analysis of a plastic article as described above. Specifically, the demonstrator of multiple stresses will make it possible to correlate the experimental results and the virtual modeling of the demonstrator and thus optimize and reinforce the results of the data of the finite element calculation models, of the injection simulation software programs and/or of the laws of behavior of the materials in compression; this will make it possible thereafter to produce technical plastic articles with better efficiency; for example by the choice of the injection points of the molten material, the design of the parts, the injection molding parameters and the formulation of the plastic material. This will also make it possible to optimize the design of the mold by avoiding use of costly physical prototypes.

A specific language is used in the description so as to make it easier to understand the principle of the invention. It must nevertheless be understood that no limitation of the scope of the invention is envisaged by the use of this specific language. Modifications, improvements and enhancements may notably be envisaged by a person who is familiar with the technical field involved on the basis of his own general knowledge.

The term and/or includes the meanings and, or, and all the other possible combinations of the elements associated with this term.

Other details or advantages of the invention will appear more clearly on seeing the examples given below only as an indication.

1. An article made in a single piece by injection molding of a plastic formulation and comprising:
an oblong, ribbed central beam (1), and
two ribbed plates (2) which are placed symmetrically and perpendicularly at the ends of said beam; each plate comprising at least two through-holes (3).

2. The article as defined by claim 1, wherein section of the ribbed beam is rectangular, T-shaped, U-shaped, I-shaped or dumbbell-shaped.

3. The article as defined by claim 1, wherein the plates have rectangular or circular shapes.

4. The article as defined by claim 1, wherein the bearing face of a plate on the beam has a tapered and curvilinear shape in its connection to the beam.

5. The article as defined by claim 1, wherein section of the ribbed beam has a dumbbell shape, and the plates are of circular shape; and wherein a bearing face of a plate on the beam has a tapered and curvilinear shape in its connection to the beam; in order to link a rectangular section of the beam and a circular section of the plate.

6. The article as defined by claim 1, wherein the plates are reinforced by a network of ribs situated on a face opposite to a bearing face on the beam.

7. The article as defined by claim 1, wherein the plates each comprise between four and ten holes.

8. The article as defined by claim 1, wherein the plastic formulation is based on a thermoplastic material selected from the group consisting of polyolefins, polyamides and polyesters.

9. The article as defined by claim 1, wherein the plastic formulation comprises reinforcing or additive fillers.

10. A method of evaluating mechanical stresses, the method comprising using the article as defined by claim 1, wherein the article serves as a demonstrator of multiple stresses.

11. A method for optimizing the structural analysis of a plastic article, the method comprising at least the following steps:
a) carrying out experimental tests of mechanical stresses on the article;
b) carrying out simulations of transformation by injection molding and calculations of mechanical stresses on a virtual model of a demonstrator of step a); and
c) correlating results of steps a) and b) so as to improve a finite element computing model and laws of behavior of materials.

12. The method as defined by claim 11, wherein the method is used to produce a plastic article by injection molding.

13. A method for manufacturing a plastic article by injection molding, the method comprising developing said plastic article using the article as defined by claim 1.

14. A method for manufacturing a plastic article by injection molding, the method comprising developing said plastic article using the optimized structural analysis method defined by claim 11.
